(19) United States
(12) Patent Application Publication
(10) Pub. No.: US 2021/0122901 A1
(43) Pub. Date: Apr. 29, 2021

(54) FLAME RETARDANT THERMOPLASTIC COMPOSITION, A MOLDED BODY OBTAINED FROM THE THERMOPLASTIC COMPOSITION, A COMPOUND CONSTRUCTION BODY CONTAINING THE THERMOPLASTIC COMPOSITION AND/OR THE MOLDED BODY, AND THE USE OF THE THERMOPLASTIC COMPOSITION, THE MOLDED BODY AND THE COMPOUND CONSTRUCTION BODY

(71) Applicant: Woco GmbH & Co. KG, Bad Soden-Salmuenster (DE)

(72) Inventor: Janos Kertesz, Bad Soden-Salmuenster (DE)

(21) Appl. No.: 17/082,999

(22) Filed: Oct. 28, 2020

(30) Foreign Application Priority Data
Oct. 28, 2019 (DE) 102019129040.6

(51) Int. Cl. C08K 13/02; B32B 15/20; B32B 15/08; B32B 27/12; B32B 5/02; B32B 1/08; B32B 27/20; B32B 27/32; B32B 27/34; B32B 27/28; B32B 27/36; B32B 27/30

(52) U.S. Cl. CPC C08K 13/02; B32B 2471/00; B32B 15/08; B32B 27/12; B32B 5/024; B32B 5/026; B32B 5/022; B32B 1/08; B32B 27/20; B32B 27/32; B32B 27/34; B32B 27/281; B32B 27/36; B32B 27/306; B32B 27/308; B32B 2262/101; B32B 2262/106; B32B 2262/02; B32B 2255/26; B32B 2419/00; B32B 2605/00; B32B 2597/00; B32B 2307/3065; B32B 2457/00; B32B 15/20

(57) ABSTRACT

A flame retardant thermoplastic composition includes a thermoplastic polymer with a glass transition temperature of less than or equal to 0° C. and a melt mass flow rate in the range of 0.5 to 60 g/10 min, an inorganic filler, a metal hydroxide flame retardant, a compound containing boron, and optionally an additive. Further disclosed is a molded body obtained from the thermoplastic composition and the use of said molded body for the production of everyday items of use.

### BACKGROUND

### Technical Field

The present disclosure relates to a flame retardant thermoplastic composition. The present disclosure further relates to a molded body obtained or obtainable from the thermoplastic composition according to the present disclosure. The present disclosure additionally relates to a compound construction body containing the thermoplastic composition according to the disclosure and/or the molded body according to the disclosure and the use of the thermoplastic composition according to the disclosure, the molded body according to the disclosure and the compound construction body according to the disclosure.

### Description of the Related Art

Synthetic materials are used for a variety of applications in everyday life and in technically complex products. This also applies to thermoplastic synthetic materials. Thermoplastic synthetic materials are characterized by the fact that they can be transformed into a molten state through heating without the polymer material being destroyed or fundamentally changed. This property is used in order to form molded bodies with a wide range of different geometries from these materials, with the aid of suitable tools. After cooling, the thermoplastic material retains this form. This procedure can usually be repeated as often as required. Due to their carbon backbone, thermoplastic synthetic materials are generally combustible or flammable, which is why molded bodies produced from these materials are usually equipped with fire retardants or flame retardants. For a long time, compositions containing phosphorous and halogen have been used as flame or fire retardants in thermoplastic polymers.

For example, according to WO 2009/040772, thermoplastic molding compounds containing 55 to 97 wt % of a polycarbonate, 1 to 25 wt % of a special polysiloxane polycarbonate, 1 to 10 wt % of an impact modifier and 1 to 10 wt % of a filler, with an average particle size D50 of less than 2.7 μm, are to be equipped with a flame retardant containing phosphorous or halogen in order to obtain flame retardant products.

EP 1 791 902 B1 is based on molding compounds containing A) 20 to 97 wt % of an unbranched thermoplastic polyamide, B) 1 to 30 wt % of special phosphinic acid salts, C) 1 to 40 wt % of a flame retardant combination containing nitrogen from C1) 0.1 to 25 wt % melamine cyanurate and C2) 0.1 to 25 wt % of a conversion product of the melamine with phosphoric acid or condensed phosphoric acids and D) 0.1 to 10 wt % of at least one metal compound selected from the group consisting of ZnO, ZnS, TiO₂, MgCO₃, CaCO₃, zinc borate, CaO, MgO, Mg(OH)₂, TiN, boron nitride, Mg3N2, Zn₃N₂, Zn₃(PO₄)₂, Ca₃(PO₄)₂, calcium borate and magnesium borate. Adequate flame retardance for polyamide compounds can be obtained according to EP 1 791 902 B1 through the use of compositions containing phosphorous.

An optimal form of equipment for a thermoplastic molded body for a respective intended use, with a suitable flame or fire retardant, is nevertheless still not obtainable in a trivial manner for a person skilled in the art, particularly if the use of flame retardants that contain phosphorous and halogen is to be avoided. This is due to the fact, among other things, that synthetic materials are increasingly replacing metal components, either for cost reasons or in order to reduce weight. Such thermoplastic molded bodies are in some cases exposed to thermal loads, and not seldom also to continuous thermal loads, such as when used under an engine hood, which make it absolutely necessary to provide high-quality flame and fire retardance. It would be desirable to be able to have recourse to thermoplastic molded bodies which are inflammable or have very low flammability in cases of fire.

There is thus accordingly a need to obtain molded bodies made of thermoplastic polymers that have very low flammability and/or very low combustibility. In some cases there is also a need to make accessible molded bodies made of thermoplastic polymers which can be used under thermally difficult conditions without presenting a fire hazard.

### DETAILED DESCRIPTION

Accordingly, the present disclosure provides a flame retardant thermoplastic composition which is formed of or comprises
a) at least one thermoplastic polymer with a glass transition temperature T_{G} according to DIN EN ISO 11357-2:2013-09 of less than or equal to 0° C. and a melt mass flow rate according to DIN EN ISO 1133-1:2012-03 in the range of 0.5 to 60 g/10 min, in some cases in the range of 0.5 to 50 g/10 min, determined at a test temperature of 190° C. and a test load of 2.16 kg,
b) at least one inorganic filler,
c) at least one metal hydroxide flame retardant,
d) at least one compound containing boron, selected from the group consisting of boric acid, boron oxide, inorganic borates, boron carbide, boron nitride, and mixtures thereof, and
e) optionally at least one additive, in some cases comprising UV stabilizers, heat stabilizers, and/or processing aids.

With the thermoplastic compositions according to the present disclosure, it is possible to access thermoplastic molded bodies that make do entirely without flame retardants containing halogen and phosphorous, while nevertheless securing reliable, high-quality flame retardance. In some embodiments, the thermoplastic compositions according to the disclosure are accordingly substantially free of flame retardants containing halogen and/or phosphorous.

In some cases the at least one thermoplastic polymer of the thermoplastic compositions according to the present disclosure has a glass transition temperature T_{G} according to DIN EN ISO 11357-2:2013-09 of less than or equal to −10° C., in some other cases of less than or equal to −20° C. and in some further cases of less than or equal to −40° C. An object of the present disclosure is thereby satisfactorily achieved when, for the thermoplastic compositions according to the present disclosure, as an addition or an alternative, recourse is made to thermoplastic polymers that have a melt mass flow rate according to DIN EN ISO 1133-1:2012-03 in the range of 0.5 to 25 g/10 min, in some cases in the range of 1.0 to 20 g/10 min, in some other cases in the range of 2.0 to 15 g/10 min and in some further cases in the range of 4.0 to 12 g/10 min, determined at a test temperature of 190° C. and a test load of 2.16 kg. Suitable thermoplastic polymers are characterized by a thermal decomposition temperature of higher than 250° C., in some cases higher than 300° C., and in some further cases higher than 320° C.

In general, for the thermoplastic compositions according to the present disclosure, recourse can be made to thermoplastic polymers selected from the group consisting of polyolefins, in some cases polyethylene, polypropylene and/or ethylene/alpha-olefin copolymers, polyamides, polyimides, polyesters, in some cases PET and/or PBT, ethylene/vinyl acetate copolymers, thermoplastic elastomers, e.g., ethylene/1-alkylene copolymers such as ethylene/1-octen copolymers, polyacrylates, ethylene/vinyl acetate copolymers, acrylate copolymers, in some cases ethylene/(meth)acrylate copolymers or butyl/(meth)acrylate copolymers, acrylate copolymers containing polymerized maleic anhydride comonomer units, and mixtures thereof. Here, polyolefins, in some cases polyethylene, polypropylene and/or ethylene/alpha-olefin copolymers, polyester, in some cases PET and/or PBT, ethylene/vinyl acetate copolymers, acrylate copolymers, in some cases ethylene/(meth)acrylate copolymers or butyl/(meth)acrylate copolymers, and/or acrylate copolymers containing polymerized maleic anhydride comonomer units have been shown to be expedient. Examples of suitable thermoplastic polymers are those containing polymerized maleic anhydride comonomer units or grafted maleic anhydride units, wherein among these, acrylate copolymers containing polymerized maleic anhydride comonomer units or grafted maleic anhydride units can be used in the present disclosure. And of the ethylene/(meth)acrylate copolymers, recourse is in some cases made, inter alia, to ethylene/n-butyl acrylate copolymers.

In some cases, the thermoplastic polymers used for the thermoplastic compositions according to the present disclosure of component a) referenced above comprise at least one polyolefin, in some cases polyethylene, polypropylene and/or ethylene/alpha-olefin copolymers, an ethylene/vinyl acetate copolymer and at least one acrylate copolymer, in some cases an ethylene/(meth)acrylate copolymer or butyl/(meth)acrylate copolymer. In the thermoplastic compositions according to the present disclosure, component a) is present in some cases in quantities in the range of 10 to 75 wt %, in some other cases in the range from 15 to 65 wt %, and in some further cases in the range from 15 to 60 wt % or 20 to 60 wt %. Alternatively or in addition, it can in this case be provided that component a) is present or used in full or in parts, e.g., in parts, in the form of a plastisol, in some cases containing the at least one polyolefin. In general, plastisols are dispersions of thermoplastic polymers present in powder form and a liquid softening agent. These dispersions can, for example, also contain pigments, fillers and/or additives. For softening agents, recourse can be made, for example, to phthalic acid esters such as dioctylphthalate and/or 1,2-cyclohexane dicarboxylic acid diisononyl ester, dibenzylsuccinates, dinonyl succinates, didecyl succinates, benzyl-2-propylheptylsuccinate and/or benzylisononylsuccinates. In some cases, polymers are used for the plastisols that are not soluble, or only poorly soluble, in the softening agent, which however in some cases permit an infusion of the softening agent at higher temperatures, e.g., in the range of 160 to 200° C., which entails a plastification of the polymer material. Prior to this, the plastisol is usually still pourable, injectable, and spreadable. During cooling, a gel-like mass is obtained therefrom, with a highly viscous consistency, which is no longer flowable at room temperature. In the literature, the term plastisol is used both for the unhardened mixture described above and for the finished product present in a highly viscous consistency. According to the present disclosure, the term plastisol means the unhardened mixture described here.

In the thermoplastic compositions according to the present disclosure, the proportion of plastisol in relation to the total weight of the thermoplastic composition is in some cases in the range of 0.5 to 20 wt %, in some other cases in the range of 1 to 15 wt %, and in some further cases in the range of 5 to 10 wt %. If, in the thermoplastic compositions according to the present disclosure, the plastisol is only present proportionately, the quantity of the thermoplastic polymer that is present or used in the plastisol, in relation to the total quantity of the thermoplastic polymer, formed by the quantity not present in the plastisol and the quantity present or used in the plastisol, is in some cases in the range of 0.01 to 15 wt %, and in some other cases in the range of 0.5 to 10 wt %.

If plastisol is present in the thermoplastic compositions according to the present disclosure, for this purpose, in some cases recourse is proportionally preferably made to polyolefins, such as polyethylene, polypropylene and/or ethylene/alpha-olefin copolymers. For the thermoplastic polymer not present in the plastisol, acrylate copolymers are in some cases used here, such as butyl acrylate copolymers and/or ethylene/acrylate copolymers, in some cases ethylene butyl acrylate.

In at least some embodiments, an object of the present disclosure is achieved in a satisfactory manner by a thermoplastic composition in which component a) is an ethylene/(meth)acrylate copolymer, in some cases selected from the group consisting of ethylene methyl acrylates (EMA), ethylene ethyl acrylates (EEA), ethylene butyl acrylates (EBA), and mixtures thereof. Polyolefins that are selected from the group consisting of LD polyethylene, LLD polyethylene, and mixtures thereof have also in some cases shown to be advantageous. Further, butyl acrylate copolymers are in some cases used as the butyl/(meth)acrylate copolymers. Among the ethylene/(meth)acrylate copolymers and in some cases also as component a), ethylene butyl acrylate is used in some cases, wherein recourse is in some other cases made to ethylene butyl acrylate containing polymerized maleic anhydride comonomer units.

In addition, such thermoplastic compositions have been shown to be advantageous in order to satisfactorily achieve an object of the present disclosure in which the total quantity of the at least one thermoplastic polymer or a part thereof comprises units capable of crosslinking. Here, in some expedient embodiments, the thermoplastic polymer with units capable of crosslinking can comprise peroxidically crosslinkable units, units that are crosslinkable by means of electron radiation and/or units that are crosslinkable by means of UV radiation. Alternatively or in addition, the thermoplastic polymer with units capable of crosslinking can be a silane-grafted thermoplastic polymer.

In order to obtain silane crosslinked thermoplastic compositions according to the present disclosure, in a first step, silane molecules are grafted onto the thermoplastic polymer, i.e., onto its polymer chain or polymer backbone. To this end, recourse is in some cases made to polyolefins, such as polyethylene. Here, radicals can be formed with thermoplastic polymers through conversion with radical initiators such as peroxides, which react with suitable silane molecules, particularly those with a residue containing a carbon/carbon double bond, forming a covalent bond. Thus, a thermoplastic polymer grafted with silane molecules is obtained. Suitable silane molecules are, for example, vinyl silane, particularly vinyltrialkoxysilane and vinyltrimethoxysilane. The crosslinking of thermoplastic polymers that are grafted in this manner then occurs in a downstream step in the presence of water, in each case via the reaction of two silane units to an Si—O—Si bridge. This crosslinking is a so-called polycondensation reaction. This reaction can be accelerated by increasing the temperature, for example, by heating to temperatures above 80° C., and/or through the presence of crosslinking catalysts such as dioctyltin dilaurate. In one embodiment variant, the thermoplastic polymer or the molded bodies obtained therefrom containing thermoplastic polymers can, for example, be stored in hot water with reactive groups that are capable of crosslinking, or exposed to water vapor, in some cases at temperatures in the range of 80 to 95° C.

The molded bodies according to the present disclosure can be obtained from the thermoplastic compositions according to the present disclosure in a one-step process and a two-step method. In the single-step process, the silane grafting and the transfer of the thermoplastic composition according to the present disclosure to a molded body, in some cases by means of extrusion, is conducted in a single method step. With the two-step method, the thermoplastic polymer is in a first step compounded and granulated together with the silane compound and a radical initiator, such as a peroxide, and optionally an antioxidant. A crosslinkable, Si-grafted polymer granulate is obtained. This silane-grafted polymer granulate is mixed with a so-called catalyst masterbatch, in some cases containing the same thermoplastic polymer as the Si-grafted polymer granulate, however without grafted silane molecules, together with the crosslinking catalyst and the additives, under conditions that initiate a silane crosslinking forming Si—O—Si bridges. This is achieved, for example, by mixing the thermoplastic polymer grafted with the silane compound with the catalyst masterbatch, for example, at a ratio of 95%:5% on an extrusion plant directly before processing, and extruding it to form the desired molded body.

In order to obtain crosslinked thermoplastic compositions according to the present disclosure, these can also be equipped with peroxidic crosslinking agents (component f)). Suitable peroxidic crosslinking agents comprise, e.g., 2,2-dimethyl-2,5-di(tert-butylperoxy)-3-hexyne, di-tert-butyl-1,1,4,4-tetramethylbutyl-2-in-1,4-ylendiperoxide, 2,5-dimethyl-2,5-di(tert-butylperoxy)-hexane, 1,3-phenylenbis(1-methylethylidene))bis(tert-butyl)peroxide, 1,4-phenylenbis(1-methylethyliden))bis(tert-butyl)peroxide and di-(2-tert-butyl-peroxyisopropyl)benzol.

Suitable inorganic fillers (component b) referenced earlier) in some cases comprise metal oxides such as aluminum oxide, titanium oxide and/or magnesium oxide, metal carbides such as silicon carbide, titanium carbide, boron carbide, zirconium carbide and/or aluminum carbide, metal nitrides such as aluminum nitride, magnesium silicon nitride, titanium nitride and/or silicon nitride, graphite, barium sulphate, calcium sulphate, glass fillers or combinations of these compounds. For the thermoplastic compositions according to the present disclosure, in some cases such inorganic fillers are used that are low melting glass powders, wherein glass powders with a melting point in the range of 390 to 900° C., and wherein recourse is in some cases made to glass powders with a melting point in the range of 400 to 780° C. In the thermoplastic compositions according to the disclosure, component b), i.e., the inorganic filler, is present particularly in a quantity in the range of 2 to 80 wt %, in some other cases in the range of 15 to 75 wt %, and in some further cases in the range of 25 to 70 wt %.

Suitable metal hydroxide flame retardants (component c) referenced earlier), which can be used in the thermoplastic compositions according to the present disclosure, are aluminum hydroxide and/or magnesium hydroxide.

For component d) of the thermoplastic compositions according to the present disclosure, recourse is in some cases made to boron nitride and/or inorganic borates, wherein among the inorganic borates, zinc borate is used in some cases.

Suitable additives (component e) referenced earlier) for the thermoplastic compositions according to the present disclosure can, e.g., be pigments, antioxidants, light stabilizers, UV stabilizers, color stabilizers, heat stabilizers, processing aids or any mixtures of these. Suitable additives for thermoplastic compositions are generally known to a person skilled in the art. For example, recourse can be made to oil and wax components, e.g., stearates, for the processing aids.

Additionally, such thermoplastic compositions according to the present disclosure have been shown to be suitable in order to obtain molded bodies that are characterized by excellent noise protection, which further contain at least one physical and/or chemical blowing agent (component g)). This can, for example, be an encapsulated physical or chemical, e.g., a physical, blowing agent in a hollow microsphere, in some cases in the form of a thermoplastic polymer sheath.

Accordingly, in some embodiments, the thermoplastic compositions according to the present disclosure may comprise
a) at least one thermoplastic polymer with a glass transition temperature T_{G} in accordance with DIN EN ISO 11357-2:2013-09 less than or equal to 0° C. and a melt mass flow rate in accordance with DIN EN ISO 1133-1:2012-03 in the range from 0.5 to 60 g/10 min, determined at a test temperature of 190° C. and a test load of 2.16 kg
b) at least one inorganic filler,
c) at least one metal hydroxide flame retardant,
d) at least one boron-containing compound selected from the group consisting of boric acid, boric oxide, inorganic borates, boron carbide, boron nitride, and mixtures thereof,
g) at least one physical and/or chemical blowing agent, and
e) optionally, at least one additive, in some cases comprising UV stabilizers, heat stabilizers, and/or processing aids.

Suitable thermoplastic compositions according to the present disclosure may comprise,
10 to 75 wt %, in some cases 15 to 60 wt % or 15 to 65 wt %, and in some further cases 10 to 40 wt % or 20 to 40 wt % % or 20 to 65 wt %, and in even further cases 15 to 60 wt %, of component a) (thermoplastic polymer),
2 to 50 wt % or 2 to 80 wt %, in some cases 5 to 40 wt % or 15 to 75 wt %, and in some further cases 10 to 30 wt % or 25 to 70 wt % of component b) (inorganic filler),
10 to 90 wt %, in some cases 25 to 75 wt % and in some further cases 10 to 60 wt %, of component c) (metal hydroxide flame retardant),
0.1 to 15 wt %, in some cases 1 to 10 wt % and in some further cases 1 to 10 wt %, of component d) (compound containing boron),
0 to 5 wt %, in some cases 0.1 to 2 wt % of component e) (additive),
0 to 10 wt %, in some cases 0.2 to 2 wt % of component f) (crosslinking agent), and
0 to 5 wt %, in some cases 1 to 3 wt % of component g) (blowing agent),
wherein the components that form the flame retardant thermoplastic composition always supplement each other to 100.0 wt %.

Such thermoplastic compositions according to the present disclosure solve the problem underlying the invention well, which are formed of or comprise
a) 15 to 60 wt. % of at least one thermoplastic polymer with a glass transition temperature T_{G} in accordance with DIN EN ISO 11357-2:2013-09 of less than or equal to 0° C. and a melt mass flow rate in accordance with DIN EN ISO 1133-1:2012-03 in the range from 0.5 to 60 g/10 min, determined at a test temperature of 190° C. and a test load of 2.16 kg, comprising at least one polyolefin, an ethylene/vinyl acetate copolymer, and/or at least one acrylate copolymer,
b) 2 to 50 wt. % of at least one inorganic filler,
c) 10 to 90 wt. % of at least one metal hydroxide flame retardant,
d) 0.1 to 15 wt. % of at least one boron-containing compound selected from the group consisting of boric acid, boric oxide, inorganic borates, boron carbide, boron nitride, and mixtures thereof, and
e) 0 to 5 wt. % of at least one additive, in some cases comprising UV stabilizers, heat stabilizers and/or processing aids,
wherein the components forming the flame retardant thermoplastic composition always add up to 100.0 wt. %.

The present disclosure further provides molded bodies, obtained or obtainable by means of injection molding, extruding, blow molding, compression molding, deep drawing, vacuum molding, resin transfer molding (RTM), roller rotation, rotation molding, laser sintering, fused deposition modeling (FDM), granulating and/or pouring the thermoplastic composition according to the present disclosure. The molded bodies according to the present disclosure are regularly characterized by a very good low-temperature impact strength. This also applies in some cases to those molded parts that utilize thermoplastic compositions according to the present disclosure, in which component a) is or comprises ethylene/(meth)acrylate copolymers, in some cases ethylene butyl acrylates (EBA).

The molded bodies according to the present disclosure are, for example, present as foamed molded bodies.

Such molded bodies achieve an object of the present disclosure well in which the at least one thermoplastic polymer is contained therein as a polymer that is crosslinked at least in parts, in some cases obtained by means of a silane-grafted thermoplastic polymer, wherein for this purpose, recourse is in some cases made to one-step or two-step silane crosslinking.

Molded bodies according to the present disclosure are in some cases characterized by an elongation at break according to DIN EN ISO 527-1:2012-06 in the range of 10 to 180%, in some further cases in the range of 20 to 180%, and some other cases in the range of 30 to 120 and in even some further cases in the range of 30 to 90%. Satisfactory elongation at break values are in some cases also obtainable with those molded bodies according to the present disclosure that are formed from thermoplastic compositions according to the disclosure containing proportions of plastisols, such as described above.

The molded bodies according to the present disclosure may, for example, be a foil layer, disc, or panel, each with a front and an opposite rear side.

Further advantageous embodiments of the molded bodies according to the present disclosure, such as those in the form of a foil layer, disc, or panel, have on at least one side, in some cases the front side or the rear side, or also on the front and rear side, at least one metal foil, such as an aluminum foil, and/or at least one, in some cases wide-mesh, fiber layer.

The, in some cases wide-mesh, fiber layers can here be, for example, selected from the group consisting of glass fiber layers, carbon fiber layers, synthetic fiber layers, or any mixtures thereof. Suitable synthetic fibers are, e.g., polyester fibers, polyamide fibers, or aramid fibers, wherein aramid fibers are preferred in some cases. The fiber layer, such as the glass fiber layer, can be a fleece, woven, knitted, non-woven, or textile layer. The fiber layer is in some cases formed from continuous fibers.

In advantageous embodiments, the molded bodies according to the present disclosure also comprise so-called sandwich molded bodies. In said bodies, the at least one metal foil and/or the at least one fiber layer is embedded in the molded body. In this case, the metal foil, such as the aluminum foil, in some cases has an average thickness in the range of 10 to 250 μm, and in some further cases in the range of 15 to 75 μm.

For example, in one suitable embodiment, on the one side of the molded body according to the present disclosure, for example, on the front side, a fiber layer can be present, in some cases containing or formed from glass fibers, and on the opposite side of the molded body, for example, on the rear side, a metal foil, such as an aluminum foil, can be present. For molded parts that achieve an object of the present disclosure well, in the embodiment named above, the thermoplastic composition present between the fiber layer and the metal foil is present in a foamed and/or crosslinked form, in some cases in a foamed and crosslinked form, wherein the crosslinking is some further cases based on the at least one proportionate use of thermoplastic polymers with units capable of crosslinking, in some cases on the use of silane-grafted thermoplastic polymers.

If a fiber layer, such as a glass fiber layer, e.g., a fiber fabric, a fiber fleece or a non-woven fiber, is embedded in a thermoplastic composition according to the present disclosure, a molded body according to the present disclosure in the form of a so-called organic sheet can be obtained from this. During the production of organic sheets, relatively high pressures can generally be used. Organic sheets can generally be brought into their final form using deep drawing. The deep-drawn organic sheet is already the end product with the equipment described. Organic sheets can, however, also be, e.g., so-called fiber-matrix semifinished products. Accordingly, the present disclosure also comprises, in some cases hot workable, semifinished products, such as fiber matrix semifinished products, and in some cases those semifinished products in the form of or as organic sheets, in each case on the basis of the thermoplastic compositions according to the present disclosure.

Organic sheets according to the present disclosure are in some cases hot workable semifinished products. They can also be used, for example, in the automobile industry. Here, it is advantageous that organic sheets enable short process times, in some cases also compared to conventional duroplastic fiber-reinforced plastics. This is of great interest in the automobile industry with its short process times. Frequently used fiber layers, such as non-woven fiber, fiber fleece and fiber fabric, of organic sheets, are in some cases based on glass, aramid, and carbon fibers, e.g., glass fibers. In some cases those organic sheets according to the present disclosure are used in which the fibers of the fiber layers, such as of the non-woven fiber and fiber fabric, essentially run at right-angles to each other. As a result, molded bodies are obtained with good mechanical properties, for example, with regard to rigidity, strength and/or thermal expansion.

In the molded bodies, such as organic sheets, of the present disclosure, continuous fibers and/or long fibers, in some cases continuous fibers, are used. The fiber length of the long fibers is here generally in the range of 1 to 50 mm according to the present disclosure, while fibers that are longer than 50 mm are described as continuous fibers according to the present disclosure. In some cases organic sheets are used on the basis of continuous fibers.

An organic sheet according to the present disclosure can be used as a so-called semifinished product for the production of finished parts. For this purpose, the organic sheet can first be brought into a specific form, for example, using the deep drawing method. Then, this semifinished product can be heated until just below the melting point of the plastic material of the synthetic material matrix of the organic sheet and inserted into an injection molding tool and overmolded. In some cases when the organic sheet is pre-heated, very good adhesion to the thermoplasts used for encasement occurs as a result. Due to the heating of the organic sheet, a deep connection is regularly created via the entire contact surface with the thermoplastic polymers used for overmolding, namely in the form of a force-fit connection. In many cases it can be advantageous, in some cases also for reasons of better recycling, for the matrix material of the organic sheet, as well as for the synthetic material used for overmolding the organic sheet, to have recourse to the same thermoplastic polymer, for example, polyamide or polyolefins, such as polyethylene or polypropylene.

It has been shown to be advantageous, when organic sheets are used, to use thermoplastic polymers with units capable of crosslinking, at least proportionately. In this case, recourse is in some cases made to silane-grafted thermoplastic polymers. If such organic sheets are used as semifinished products, in order to be encased with a thermoplastic material, for example, e.g., by means of injection molding, it has been found to be highly advantageous in some cases to conduct the crosslinking of the units capable of crosslinking of the thermoplastic composition according to the present disclosure first, at least proportionately, when the organic sheet is embedded in the finished thermoplastic product. In this manner, an even stronger connection with the thermoplastic material used for the encasement, for example, can be produced. Deformability is also guaranteed over the longest possible period of time.

The present disclosure further provides a compound construction body comprising a construction material body, such as an essentially mineral construction material body, and a thermoplastic composition according to the present disclosure, and/or a molded body according to the Present disclosure.

Suitable compound construction bodies according to the present disclosure are also characterized by the fact that the construction material body, in some cases the essentially mineral construction material body, is or comprises a coating made of the thermoplastic composition according to the present disclosure or the molded body according to the present disclosure. In this case the molded body can be a foamed molded body. With the compound construction bodies according to the present disclosure, the molded body according to the disclosure is present in some cases in the form of a foil layer disc, or panel, in some further cases laminated onto the construction material body, such as the mineral construction material body.

For example, the construction material body, such as the essentially mineral construction material body, can be partially or fully embedded in the thermoplastic composition according to the present disclosure or the molded body according to the disclosure.

Here, it can in some cases be provided that the construction material body is selected from the group consisting of gypsum panels, such as gypsum board panels and/or gypsum fiber panels, chipboards, metal components, in some cases metal plates, duroplastic molded bodies, such as foamed duroplastic molded bodies, thermoplastic molded bodies, WPC molded bodies, wooden panels, construction bodies, e.g., panels, from sustainable raw materials, in some cases selected from the group consisting of wood fibers, hemp fibers, flax fibers, nettle fibers, seagrass, elephant grass, mescanthum, reeds, coconut fibers, straw, and any mixture of the above mentioned sustainable raw materials, e.g., a wood fiber panel, such as an MDF or OSB panel, wood soft fiber panel or a hemp fiber insulation panel, and hard PVC panels, such as gypsum board panels and/or gypsum fiber panels. Suitable thermoplastic construction material bodies also comprise foamed building material bodies. High temperature thermoplastics are in some cases also used as thermoplastic construction material bodies. Examples are polyphenylene sulfides (PPS), polyphthalamides (PPA), snydiotactic polystyrene (SPS), polyether ketones (PEEK), and polysulfones (PSU).

Appropriate embodiments of the construction material bodies can also comprise those which have one or more punctures/holes and/or material recesses, for example, indentations, which do not pass completely through the construction material body. In that the construction material body, in some cases an essentially mineral construction material body, in some embodiments has penetrations or holes and/or material recesses, for example, indentations, through which the thermoplastic composition according to the present disclosure can penetrate in molten form during the manufacturing process, e.g., embedding, sheathing or lamination, a composite construction body is obtained which is characterized by a pronounced mechanical stability.

The molded bodies according to the present disclosure can in some cases be or be used for the production of a housing for a household appliance, such as a refrigerator, freezer, laundry dryer or washing machine, fire prevention construction part, door, window frame, tunnel housing, vehicle construction part, such as a motor, airplane, rail or cable railway vehicle, e.g., a front end and/or a gas coupling or brake pedal, an elevator component, a cable isolator, a cable conduit, a distributor box, a fuse box, a plug covering, a plug top, a switch covering, switch top, a pipe, a facade cladding, a wall cladding, a ceiling cladding, a separating wall, a battery housing, a rechargeable battery housing, a cellphone housing, an insulation, a floor panel, a fuel tank, a sheath for a fuel tank, a transformer housing, an acoustic wall, a cable isolator, a cable conduit, a facade construction element, a drywall construction component, a floor covering, ceiling element, a furniture component, or an element of the components listed above.

With the thermoplastic compositions according to the present disclosure, it is surprisingly possible to achieve very effective flame retardance in cases of fir, without requiring recourse to flame retardants containing halogen or phosphorous.

The features of the present disclosure disclosed in the above description and in the claims can be essential both individual and in any combination required for the realization of the present disclosure in its different embodiments.

The various embodiments described above can be combined to provide further embodiments. All of the patents and publications referred to in this specification and/or listed in the Application Data Sheet are incorporated herein by reference, in their entirety. Aspects of the embodiments can be modified, if necessary to employ concepts of the various patents and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A flame retardant thermoplastic composition, formed from or comprising:
a) at least one thermoplastic polymer with a glass transition temperature T_{G} according to DIN EN ISO 11357-2:2013-09 of less than or equal to 0° C. and a melt mass flow rate according to DIN EN ISO 1133-1:2012-03 in the range of 0.5 to 60 g/10 min, determined at a test temperature of 190° C. and a test load of 2.16 kg,
b) at least one inorganic filler,
c) at least one metal hydroxide flame retardant,
d) at least one compound containing boron, selected from the group consisting of boric acid, boron oxide, inorganic borates, boron carbide, boron nitride, and mixtures thereof, and
e) optionally at least one additive.

2. The thermoplastic composition according to claim 1, wherein the at least one thermoplastic polymer has a glass transition temperature T_{G} according to DIN EN ISO 11357-2:2013-09 of less than or equal to −10° C.

3. The thermoplastic composition according to claim 1, wherein the at least one thermoplastic polymer has a melt mass flow rate according to DIN EN ISO 1133-1:2012-03 in the range of 0.5 to 25 g/10 min, determined at a test temperature of 190° C. and a test load of 2.16 kg.

4. The thermoplastic composition according to claim 1, wherein the at least one thermoplastic polymer has a thermal decomposition temperature higher than 250° C.

5. The thermoplastic composition according to claim 1, wherein the at least one thermoplastic polymer is selected from the group consisting of polyolefins, polyamides, polyimides, polyesters, ethylene/vinyl acetate copolymers, thermoplastic elastomers, polyacrylates, ethylene/vinyl acetate copolymers, acrylate copolymers, acrylate copolymers containing polymerized maleic anhydride comonomer units, and mixtures thereof.

6. The thermoplastic composition according to claim 1, wherein component a) comprises at least one polyolefin, ethylene/vinyl acetate copolymer and at least one acrylate copolymer, and/or wherein component a) is present or used in full or in parts in the form of a plastisol.

7. The thermoplastic composition according to claim 5, wherein:
the acrylate copolymers are ethylene/(meth)acrylate copolymers which are selected from the group consisting of ethylene methyl acrylates (EMA), ethylene ethyl acrylates (EEA), ethylene butyl acrylates (EBA) and mixtures thereof, and/or
the polyolefins are selected from the group consisting of LD polyethylene, LLD polyethylene and mixtures thereof, and/or
the acrylate copolymers are butyl/(meth)acrylate copolymers which comprise or are butyl acrylate copolymers.

8. The thermoplastic composition according to claim 5, wherein the acrylate copolymers comprise or are ethylene butyl acrylate, or are ethylene butyl acrylate containing polymerized maleic anhydride comonomer units.

9. The thermoplastic composition according to claim 6, wherein;
the proportion of the plastisol in relation to the total weight of the thermoplastic composition is in the range of 0.5 to 20 wt %, or in the range of 1 to 15 wt %; and/or
the quantity of the thermoplastic polymer that is present or used in the plastisol, in relation to the total quantity of the thermoplastic polymer, formed by the quantity not present in the plastisol and the quantity present or used in the plastisol, is in the range of 0.01 to 15 wt %, or in the range of 0.5 to 10 wt %.

10. The thermoplastic composition according to claim 6, wherein the thermoplastic polymer present or used in the plastisol comprises or consists of the at least one polyolefin, and wherein the thermoplastic polymer not present in the plastisol comprises or consists of the at least one acrylate copolymer.

11. The thermoplastic composition according to claim 1, wherein the total quantity of the at least one thermoplastic polymer or a part thereof comprises units capable of crosslinking.

12. The thermoplastic composition according to claim 11, wherein:
the thermoplastic polymer with units capable of crosslinking comprises peroxidically crosslinkable units, or
the thermoplastic polymer with units capable of crosslinking is a silane-grafted thermoplastic polymer, or
the thermoplastic polymer with units capable of crosslinking comprises units that are crosslinkable by means of electron radiation, or
the thermoplastic polymer with units capable of crosslinking comprises units that are crosslinkable by means of UV radiation.

13. The thermoplastic composition according to claim 1, wherein the at least one compound containing boron is or consists of boron nitride and/or inorganic borates.

14. The thermoplastic composition according to claim 1, wherein the at least one inorganic filler comprises glass powder with a melting point in the range of 390 to 900° C.

15. The thermoplastic composition according to claim 1, wherein the at least one metal hydroxide flame retardant comprises or consists of aluminum hydroxide and/or magnesium hydroxide.

16. The thermoplastic composition according to claim 1, further comprising:
f) at least one peroxidic crosslinking agent, and/or
g) at least one physical and/or chemical blowing agent.

17. The thermoplastic composition according to claim 16, containing:
10 to 75 wt % or 20 to 60 wt %, of component a),
2 to 80 wt % of component b),
10 to 90 wt % of component c),
0.1 to 15 wt % of component d),
0 to 5 wt % of component e),
0 to 10 wt % of component f), and
0 to 5 wt % of component g),
wherein the components that form the flame retardant thermoplastic composition always supplement each other to 100.0 wt %.

18. A molded body, obtained or obtainable by means of injection molding, extruding, blow molding, compression molding, resin transfer molding (RTM), roller rotation, rotation molding, deep drawing, vacuum molding, laser sintering, fused deposition modeling (FDM), granulating and/or pouring the thermoplastic composition according to claim 1.

19. The molded body according to claim 18, wherein said molded body is a foamed molded body.

20. The molded body according to claim 18, wherein the at least one thermoplastic polymer is contained therein as a polymer that is crosslinked at least in parts.

21. The molded body according to claim 18, wherein said molded body has an elongation at break according to DIN EN ISO 527-1:2012-06 in the range of 10 to 180%.

22. The molded body according to claim 18, wherein said molded body is a foil layer, disc, or plate, in each case with a front and an opposite rear side.

23. The molded body according to claim 18, further comprising at least one metal foil.

24. The molded body according to claim 23, wherein the at least one metal foil is present on the front side and/or on the rear side of a foil layer, disc or plate, and/or wherein the at least one metal foil is embedded in the molded body.

25. The molded body according to claim 23, wherein the at least one metal foil comprises or consists of an aluminum foil.

26. The molded body according to claim 18, further comprising:
at least one fiber layer in the form of a glass fiber, carbon fiber, and/or synthetic fiber layer.

27. The molded body according to claim 26, wherein at least one metal foil and the at least one fiber layer are present on opposite sides of a foil layer, disc, or plate, or wherein at least one metal foil is present on the front and/or rear side of the molded body and the at least one fiber layer is embedded in a foil layer, disc, or plate.

28. The molded body according to claim 26, wherein synthetic fibers of the synthetic fiber layer comprise or consist of aramid fibers.

29. The molded body according to claim 26, wherein the at least one fiber layer is a fleece, woven, knitted, non-woven, or textile layer, and/or wherein the at least one fiber layer is formed from continuous fibers.

30. The molded body according to claim 26, wherein said molded body is a semi-finished product.

31. A compound construction body comprising a construction material body and a thermoplastic composition according to claim 1 and/or a molded body obtained by means of injection molding, extruding, blow molding, compression molding, resin transfer molding (RIM), roller rotation, rotation molding, deep drawing, vacuum molding, laser sintering, fused deposition modeling (FDM), granulating and/or pouring the thermoplastic composition according to claim 1.

32. The compound construction body according to claim 31, wherein the construction material body is selected from the group consisting of gypsum panels, chipboards, metal components, duroplastic molded bodies, thermoplastic molded bodies, WPC molded bodies, wooden panels, construction bodies from sustainable raw materials, and hard PVC.

33. The compound construction body according to claim 31, wherein the construction material body has a coating made of the thermoplastic composition or from the molded body.

34. The compound construction body according to claim 31, wherein the construction material body is partially or fully embedded in the thermoplastic composition or in the molded body.

35. The compound construction body according to claim 31, wherein the molded body is a foamed molded body.

36. The compound construction body according to claim 31, wherein the molded body is present and laminated onto the construction material body.

37. The molded body according to claim 18, wherein said molded body is a housing for a household appliance, a fire prevention construction part, a door, a window frame, a tunnel housing, a vehicle component, an elevator component, a firestop for cable penetrations, a cable duct, a distributor box, a fuse box, a socket covering, a socket top, a switch covering, a switch top, a pipe, a facade cladding, a wall cladding, a ceiling cladding, a roof cladding, a separating wall, a battery housing, a rechargeable battery housing, a cellphone housing, an insulation, a floor panel, a fuel tank, a sheath for a fuel tank, a transformer housing, an acoustic wall, a firestop for cable penetrations, a cable duct, a facade construction element, a drywall construction component, a floor covering, a ceiling element, a furniture component, or an element of the components listed above.

38. The use of a molded body according to claim 18 for the production of or as a housing for a domestic appliance, fire prevention construction part, door, window frame, tunnel housing, vehicle component, elevator component, firestop for cable penetrations, cable duct, distributor box, fuse box, socket covering, socket top, switch covering, switch top, pipe, facade cladding, wall cladding, ceiling cladding, roof cladding, separating wall, battery housing, rechargeable battery housing, cellphone housing, insulation, floor panel, fuel tank, sheath for a fuel tank, transformer housing, an acoustic wall, a facade construction element, a drywall construction component, a floor covering, a ceiling element, a furniture component or, in each case, as an element thereof.

39. The thermoplastic composition according to claim 1, wherein the at least one thermoplastic polymer has a glass transition temperature T_{G} according to DIN EN ISO 11357-2:2013-09 of less than or equal to −20° C.

40. The thermoplastic composition according to claim 1, wherein the at least one thermoplastic polymer has a melt mass flow rate according to DIN EN ISO 1133-1:2012-03 in the range of 1.0 to 20 g/10 min, determined at a test temperature of 190° C. and a test load of 2.16 kg.

41. The thermoplastic composition according to claim 1, wherein the at least one thermoplastic polymer has a thermal decomposition temperature higher than 300° C.

42. The thermoplastic composition according to claim 15, wherein the thermoplastic composition is essentially free of flame retardants containing halogen and/or phosphorus.

43. The thermoplastic composition according to claim 17, containing:
15 to 60 wt % or 15 to 65 wt % of component a),
15 to 75 wt % of component b),
25 to 75 wt % of component c),
1 to 10 wt % of component d),
0.1 to 2 wt % of component e),
0.2 to 2 wt % of component f), and
1 to 3 wt % of component g),
wherein the components that form the flame retardant thermoplastic composition always supplement each other to 100.0 wt %.

44. The molded body according to claim 20, wherein the at least one thermoplastic polymer is contained therein as a polymer that is crosslinked at least in parts obtained by means of a silane-grafted thermoplastic polymer.

45. The molded body according to claim 24, wherein the at least one metal foil is embedded in a foil layer, disc, or plate, in each case between the front side and the rear side of the molded body.

46. The molded body according to claims 26, wherein the at least one fiber layer is a wide-meshed fiber layer.
